(19) United States
(12) Patent Application Publication
(10) Pub. No.: US 2014/0154730 A1
(43) Pub. Date: Jun. 5, 2014

(54) METHOD FOR STABILIZATION OF FLUID BIOLOGICAL SAMPLES

(71) Applicants: Olof Sköld, Goteborg (SE); David Zee-Berg, Vastra (SE); Karl Sköld, Uppsala (SE); Mats Borén, Uppsala (SE)

(72) Inventors: Olof Sköld, Goteborg (SE); David Zee-Berg, Vastra (SE); Karl Sköld, Uppsala (SE); Mats Borén, Uppsala (SE)

(73) Assignee: DENATOR AB, Göteborg (SE)

(21) Appl. No.: 14/131,721

(22) PCT Filed: Jul. 9, 2012
(86) PCT No.: PCT/SE2012/050814

§ 371 Date: Jan. 29, 2014

(30) Foreign Application Priority Data
Jul. 13, 2011 (SE) 1130068-8
Mar. 13, 2012 (SE) 1230026-5

(51) Int. Cl. G01N 1/30

(52) U.S. Cl. CPC G01N 1/30
USPC 435/29

(57) ABSTRACT

The present invention relates to a method for rapid stabilization of fluid biological samples, such as blood samples. More specifically, the method is based on heat stabilization of the fluid biological sample absorbed in a matrix.

### FIELD OF THE INVENTION

The present invention relates to a method for rapid stabilization of fluid biological samples, such as blood samples. More specifically, the method is based on heat stabilization of the fluid biological sample absorbed in a matrix.

### BACKGROUND

Pharmaceuticals are metabolized or cleared from the body through enzymatic or non-enzymatic processes. The rate of metabolism/clearens from the body is measured in the study of pharmacokinetics (PK).

Metabolism of pharmaceuticals in the body occurs mostly in the liver (hepatic metabolism) but also in circulatory system (blood) and other sites. This metabolism is dived into two phases and mainly dependent on the enzymes involved.
Phase 1: Oxidation, reduction, hydrolysis, cyclization, and decyclization addition of oxygen or removal of hydrogen.
Phase 2: Methylation, sulphation, acetylation, glucuronidation, and glutathione conjugation.

Many pharmaceuticals are produced and administered as prodrugs which require chemical or enzymatic processing in the body to become active. About 5-7% of drugs approved worldwide can be classified as prodrugs. Approximately 15% off all new drugs approved in 2001 and 2002 were prodrugs.

Prodrugs are bioreversible derivatives of drug molecules that undergo an enzymatic and or chemical transformation in vivo to release the active parent drug. Type I being those that are activated intracellularly, and Type II being those that are activated extracellularly, especially in digestive fluids or the systemic circulation.

Prodrugs of Type I can be activated intracellular in blood cells and Type II prodrugs can be processed in blood by extracellular enzymes. Activation can carry on outside the body in a sample of blood.

PK analysis of metabolism of pharmaceuticals, including prodrugs, during pre-clinical as well as clinical development involves the withdrawal and analysis of numerous blood samples. Accurate handling to avoid post-sampling metabolism and degradation and of these blood samples are needed.

Dried blood spot (DBS) analysis has been rapidly gaining momentum in the pharmaceutical industry. Economic and ethical issues surrounding laboratory animal loss and cost associated with shipping and storing biological samples has made DBS analyzing an attractive option.

DBS involves application of a blood sample on filter paper and subsequent drying of the sample. Drying of the sample is normally required for 2 hrs.

The need for drying of the samples for an extended period of time after application on filter paper is a serious limitation in the manner DBS can be applied. Filter paper with applied samples must be dried horizontally in order to reduce the effect of gravity, which requires extended space when handling larger number of samples. Before fully dried, samples are wet and require careful handling to avoid cross sample contamination, as well as contamination from the surrounding environment (FTA DMPK Cards, Instructions for use, Whatman, Rev AB 4/2011). The drying time is to a large extent dependent on ambient temperature and humidity, significantly reducing reproducibility (Denniff & Spooner, Bioanalysis (2010) 2(11), 1817-1822). Exposure to conditions of high relative humidity and temperature, can result in the integrity of the DBS sample being compromised (Denniff & Spooner, supra).

During drying post-sampling metabolism and degradation of the sample occurs. In order to limit post-sampling metabolism and degradation, filter papers coated with various inhibitors and stabilizers are utilized. The use of coated filter papers, however, generates other types of unwanted effects, such as interference of inhibitors and/or stabilizers with subsequent analysis of the samples as well as non-uniform distribution of sample generating e.g. haloeffects (Ren et al. Bioanalysis (2010) 2(8), 1469-1475).

Filtration of the blood sample on the filter paper, giving separation of blood cells and plasma, also occurs during the drying period. These unwanted processes during drying can cause inaccurate results of subsequent analysis of the DBS samples.

Stabilization of biological samples by rapid heating is described in WO 2007/024185. However, the use of this method has not been thought to be possible to apply to DBS samples. To the contrary, heating of the sample is recommended to be avoided in the handling of DBS samples, it is said to reduce analyte stability (DBS Technical Tips, Whatman, 15 Feb. 2011), or risk to deteriorate the sample (CDC, Module 14, Blood Collection and Handling—Dried Blood Spots).

### SUMMARY OF THE INVENTION

The present invention provides a method for the stabilization of fluid biological samples.

The method comprises the steps of:
(a) applying a sample of the fluid in a matrix; and
(b) rapid heating of the sample in the matrix.

The method can further comprise the step of drying the sample in the matrix, for a time sufficient to allow the sample to become completely dry, such as for at least 30 min, 40 min, 50 min, 1 hr, 2 hrs, or 3 hrs.

The drying can be performed during storage and/or shipping. Preferably in a closed container together with a drying agent such as silica.

The fluid biological sample can be selected from blood, plasma, serum, saliva, urine, synovial and cerebrospinal fluid, and tissue homogenates.

Preferably, the fluid biological sample is a blood sample.

The heating of the sample can be made by one or more of the well-known forms of heat transfer: conduction, convection or radiation, such as by microwave radiation.

The heating is preferably performed by conduction.

The heating of the sample is preferably performed to a temperature of at least 80° C., such as at least 85° C., at least 90° C., or at least 95° C., such as to a temperature of 100° C.

The heating of the sample is preferably not performed to a temperature of more than 100° C.

By rapid heating is meant that the heating of the fluid biological sample is performed within a time shorter than the time needed for the sample to dry without heating, preferably such as within 60 min, within 30 min, within 15 min, within 10 min, within 5 min, within 2 min, or within 1 min.

The heating is performed for a time sufficiently long to allow the denaturation of proteins and enzymes in the sample, such as for a period of at least 1 sec, such as 2 sec, 5 sec, 10 see, 15 sec, 20 sec, 30 sec, 1 min, 2 min, 3 min, 4 min, or at least 5min.

Rapid heating of the sample has multiple purposes,
i) to rapidly stabilize the sample minimizing the risk for contamination,
ii) to rapidly stabilize the sample allowing simplified handling, immediate storage and/or shipping,
iii) to denature enzymes that can cause post sampling enzymatic degradation and metabolism of substances and metabolites present in the sample,
iv) to eliminate the need to use matrices coated with inhibitors and/or stabilizers which are known to cause non-homogenous samples and/or interference during subsequent analysis of the samples,
v) to reduce or prevent filtration of cells in the matrix, providing a homogeneous sample, and/ or
vi) to prevent diffusion of substances and metabolites within the matrix, providing a homogeneous sample.

Without heating, stabilization of the sample is obtained only after complete drying. As the time for drying is dependent on ambient temperature and humidity, the time for drying of a sample will vary considerable dependent on the prevailing conditions causing low reproducibility and repeatability.

By rapid heating of samples for a defined period of time stabilization of the samples will be obtained after a short and defined time post-sampling, giving high reproducibility and repeatability, also between samples taken at different times and under different ambient conditions.

By rapid heating of samples stabilization of the samples will be obtained, making the conditions for the subsequent drying less critical. Subsequent drying can be allowed to be performed during storage and/or shipping, preferably in a closed container with a drying agent such as silica.

By rapid heating of samples stabilization of the samples will be obtained, allowing for simplified handling, immediate storage and/or shipping.

Rapid heating will generate a substantially homogenous sample allowing the subsequent punching and analysing of a part of the sample with high accuracy.

As demonstrated by the results presented in the Examples below, even though rapid heating of the samples only has a moderated effect on the overall drying time, rapid heating does lead to stabilization of the sample, allowing simplified handling of the samples by allowing immediate storage and/or shipping, in combination with reduced post sampling enzymatic degradation and metabolism of substances present in the sample.

Accordingly, rapid heating of a fluid sample in a matrix eliminates a number of problems associated with known techniques for handling of fluid samples, such as the problems with the present techniques for handling of DBS samples.

Definitions. By a matrix is meant a porous material.

The matrix can be made of materials selected from the following materials;
Cellulose based material exemplified but not limited to
   Nitrocellulose
   Cellulose nitrate
   Cellulose acetate
   Cellulose such as
      Whatman FTA—DMPK-A , B and C cards
      Whatman ET 31Chr
      Whatman Protein Saver TM 903® Card
      Whatman FTA Elute
      Ahlstrom 226 Specimen Collection Paper
   Mixed cellulose esters
Glass fiber media exemplified but not limited to
   Agilent Dried Matrix Spotting Cards
Plastic polymers exemplified but not limited to
   Polyester
   Polypropylene (LDPE, HDPE)
   Polyethersulfone
   Acrylic polymers
   Polytetrafluoreten (PTFE)
Mixed polymers
Polyamides
   Natural
      Wool
      Silk
   Synthetic
      Aramids
      Nylon
Metals
   Metal films and foils
   Metal meshes

The matrix can be made of mixtures of two or more of the above mentioned materials.

The matrix can be of different kinds of shapes of the above mentioned materials and with or without structure. The structure can be porous or fibrous, the fibers can be ordered, such as laterally, radially, axially or vertically.

Preferred matrices are:
Whatman DMPK-C cards
Whatman ET 31Chr
Agilent Dried Matrix Spotting Cards
Ahlstrom 226 Specimen Collection Paper

The method according to the invention can be used for the stabilization of fluid biological sample to avoid enzymatic degradation or metabolism of the following types of compounds;
Pharmaceutical compounds
Drugs
Prodrugs
Drug metabolites
Metabolites
Proteins
Peptides
Lipids
RNA
DNA

It is contemplated that any method or composition described herein can be implemented with respect to any other method or composition described herein. Similarly, any feature discussed with respect to one embodiment of the invention may be used in the context of any other embodiment of the invention.

### DESCRIPTION OF THE DRAWINGS

FIG. 1 is a graph showing the drying time on paper in room temperature of 25 μl stabilized blood sample (♦) and 25 μl un-stabilized blood sample (▪).

FIG. 2 is a graph showing the amount of metabolized Oseltamivir in samples following different treatments. Samples A were treated according to standard procedures according to manufacturer's instructions, i.e. dried in open air for 2 hrs. Samples B were dried in closed bags with silica. Samples C were heat stabilized and subsequently dried in open air. Samples D were heat stabilized and subsequently dried in closed bags with silica. Values in FIG. 2 showing % oseltamivir metabolized are mean of three samples

### EXAMPLES

### Example 1

### Drying Time of Blood Sample

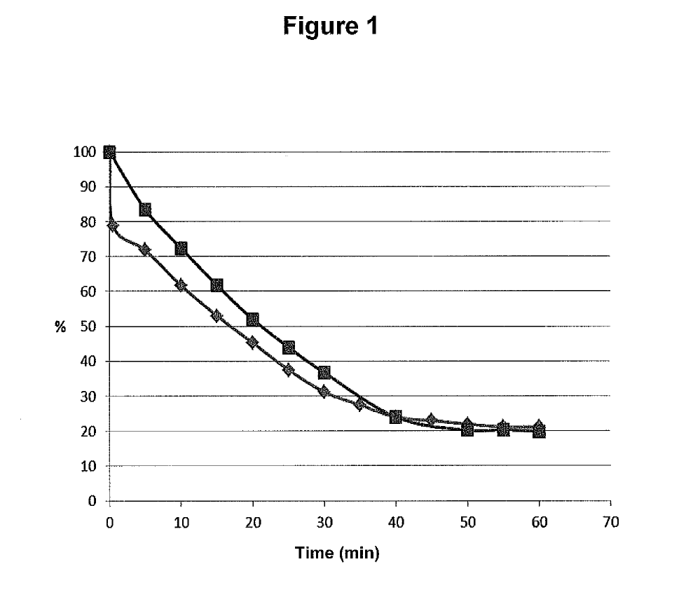

The drying time on paper in room temperature of 25 μl stabilized blood sample (-♦-) and 25 μl un-stabilized blood sample (-▪-) was monitored by weighting the paper every 5 minute. The stabilization was performed by heating for 30 seconds using a Stabilizor™ System (Denator A B, Göteborg, Sweden). After approximately 50 minutes the paper did not loss more weight. End point blood dry matter was found to be about 21% of initial weight for both samples. Results are presented in FIG. 1.

### Example 2

### Stabilization of Oseltamivir in Mouse Blood

Oseltamivir pharmacokinetics

Oseltamivir is an oral prodrug of oseltamivir carboxylate, a selective inhibitor of viral neuramidase glycoprotein in influenza A. Oseltamivir undergoes fast bioconversion to oseltamivir carboxylate mostly by carboxylesterase 1 (CES 1).

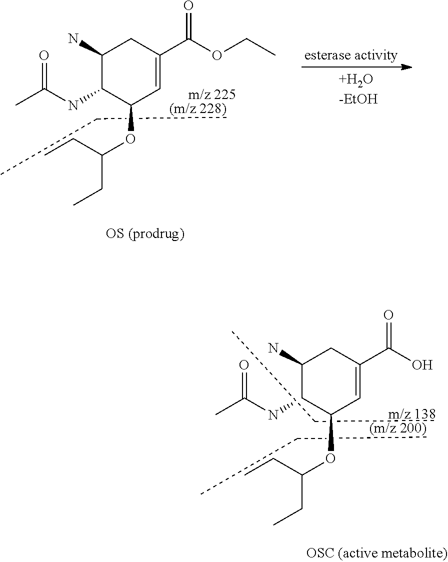

Dotted lines describe the fragmentation of the compounds during MRM measurement.

Mouse blood was spiked with oseltamivir, 500 ng/mL. 25 μL, blood was spotted on Whatman FTA DMPK-C card. Spot were left to dry at room temperature, or heat treated using a Stabilizor™ System (Denator A B, Göteborg, Sweden) then left to dry.

TABLE 1
Stabilization of oseltamivir in mouse blood

| Treatment | % oseltamivir metabolized |
|---|---|
| Drying | 27 |
| Heating | 3 |

Results

Heat treatment of sample on paper strongly reduced the metabolism of the prodrug oseltamivir, compared to only passive drying of the sample.

### Example 3

### Effect of Different Drying Conditions

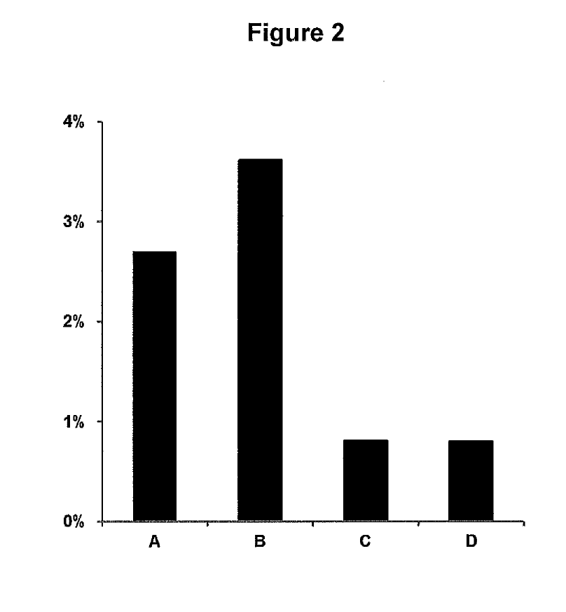

Mouse blood was spiked with oseltamivir, 2000 ng/mL. 25 μL, blood was spotted on Whatman FTA DMPK-C card. Spots were allowed to dry under different conditions, with our without prior heat stabilization. Samples A were treated according to standard procedures according to manufacturer's instructions, i.e. dried in open air for 2 hrs. Samples B were dried in closed bags with silica. Samples C were heat stabilized and subsequently dried in open air. Samples D were heat stabilized and subsequently dried in closed bags with silica. Values in FIG. 2 showing % oseltamivir metabolized are mean of three samples.

Results

There is a significant lower amount of metabolized oseltamivir in samples which have been heat stabilized. Drying of samples not heat stabilized in closed bags with silica results in an even higher amount of metabolized oseltamivir. Drying of heat stabilized samples in closed bags with silica does not affect the amount of metabolized oseltamivir, compared to drying in open air. This demonstrates that the drying time of a heat stabilized sample does not affect the amount of metabolized oseltamivir, making it possible to store and/or ship samples in bags with silica directly after collection and heat stabilization.

1. A method for the stabilization of fluid biological samples, said method comprising the steps of:
(a) applying a sample of the fluid in a matrix of a porous material; and
(b) rapid heating of the sample in the matrix.

2. The method according to claim 1 , further comprising the step:
(c) drying the sample in the matrix.

3. The method according to claim 1, wherein the fluid biological sample is selected from the group consisting of blood, plasma, serum, saliva, urine, synovial and cerebrospinal fluid, and tissue homogenates.

4. The method according to claim 3, wherein the fluid biological sample is a blood sample.

5. The method according to claim 1, wherein the matrix is composed of a material selected from the group consisting of cellulose, cellulose based materials, glass fibre media, plastic polymers, mixed polymers, polyamides, and metals.

6. The method according to claim 2, wherein the fluid biological sample is selected from the group consisting of blood, plasma, serum, saliva, urine, synovial and cerebrospinal fluid, and tissue homogenates.

7. The method according to claim 6, wherein the fluid biological sample is a blood sample.

8. The method according to claim 2, wherein the matrix is composed of a material selected from the group consisting of cellulose, cellulose based materials, glass fibre media, plastic polymers, mixed polymers, polyamides, and metals.

9. The method according to claim 3, wherein the matrix is composed of a material selected from the group consisting of cellulose, cellulose based materials, glass fibre media, plastic polymers, mixed polymers, polyamides, and metals.

10. The method according to claim 4, wherein the matrix is composed of a material selected from the group consisting of cellulose, cellulose based materials, glass fibre media, plastic polymers, mixed polymers, polyamides, and metals.
